(19) United States
(12) Patent Application Publication
(10) Pub. No.: US 2026/0326246 A1
(43) Pub. Date: Oct. 22, 2026

(54) UNIVERSAL FIXTURING SYSTEM AND METHOD OF USING SAME

(71) Applicant: Sorenson Industries LLC, Waukesha, WI (US)

(72) Inventors: Ryan Gregory Sorenson, New Berlin, WI (US); Eric Andrew Sorenson, Waukesha, WI (US)

(21) Appl. No.: 19/655,421

(22) Filed: Apr. 22, 2026

Related U.S. Application Data
(60) Provisional application No. 63/792,612, filed on Apr. 22, 2025.

(51) Int. Cl. B23K 37/04; B23K 9/095; B23K 9/28; B25J 11/00

(52) U.S. Cl. CPC B23K 37/0461; B23K 37/0426; B23K 9/0953; B23K 9/287; B25J 11/005

(57) ABSTRACT

A main base and a plurality of welding carts include complementary structures to form a float unit structure that allows a welding cart, and any other carts that are similarly configured, to immovably “dock” with the main base in a uniform fashion, thereby reducing time for adjusting each cart relative to the main base as would otherwise be required. This ensures that each welding cart that docks with the main base does so in such a way that the same precise spatial positioning between the welding robot and items secured to the welding cart are universally maintained.

### SPECIFICATION

This Application claims the priority and benefit of U.S. Provisional Patent Application No. 63/792,612, filed on Apr. 22, 2025.

### FIELD OF THE INVENTION

The present invention relates generally to robots, which are machines capable of replicating human movements or actions. Robots are programmed to perform tasks automatically in accordance with a virtually unlimited number of preprogramming schemes. Following uploading of the programming scheme, such tasks are performed autonomously and without human interaction.

The present invention also relates to cooperative or collaborative robot devices, i.e., cobots. Cobots are machines that generally require a human operator to interact physically with the robot to effectively “train” (or “teach”) the cobot to perform a task.

More specifically, the present invention offers a universal docking base capable of mating precisely with a plurality of rolling welding carts, each having a weld table, precision alignment pins and mechanical or electromechanical hardware for quick and repeatable welding cart docking with the docking base. Like its robot counterpart, the cobot docking base can be used with an unlimited number of programming schemes. The system of the present invention is not limited to welding applications. Further, a main base and each cart that can “dock” with the main base is provided with base-side and cart-side portions of a “float unit structure”.

### BACKGROUND OF THE INVENTION

Robotics is the intersection of science, engineering and technology that produces machines that replicate or substitute for human actions. Indeed, many industrial human actions have been replaced by robots. Once programmed, the robot can function autonomously and without any further human interaction until the task is completed. On the other hand, cooperative or collaborative robot devices, i.e., cobots, are devices that generally require a human operator to interact physically with the robot to perform a task, such as manipulating a tool, rather than the robot acting autonomously based on little or no human instruction beyond its programmed scheme. In certain applications, robot alignment can be a potential problem because improper alignment can adversely impact the robotic task outcome. That is, tolerance and alignment issues arise in robotic welding with larger/longer weldments, when multiple weld carts need to be combined, or due to shop floor irregularities. One such problem is in the area of repeatable alignment. In a situation where the robotic task is precision welding, misalignment can result in faulty welds or welds being improperly placed. In such an application, a human working with a cobot can be particularly useful for performing tasks requiring a level of precision that is difficult or impossible for a robot to attain without assistance. As used herein, the terms “robot” and “cobot” can be used interchangeably, although there is the stated difference in functionality and these inventors will consider the term “cobot” to cover all robotic machinery.

The system of the present invention provides users with a relatively simple solution to an ongoing problem in the robot welding industry of optimizing “arc-on” time and increased flexibility for limitations due to size and shape of parts or assemblies to be welded. In accordance with the system and method of the present invention, off-site part and tooling preparation can continue while the cobot is working. Interchangeable part and fixture setups in accordance with the present invention allow production of the type often only seen in much more expensive industrial robot carousel style cells. Using the system and method of the present invention, an infinite number of widely used and advantageous, progressive fixturing solutions are easily achievable with two or more weld carts. Further, large parts can be programmed and moved precisely with a great degree of repeatability using multiple carts linked together precisely or utilizing access on multiple sides of carts. The tolerance and alignment issues discussed earlier are effectively eliminated.

The above solutions are achieved with the use of a novel floating unit structure that allows for precision mating surfaces to overcome irregularities present in attempted solutions of this style. In view of the foregoing and in the view of these inventors, performance of the system of the present invention does not conform with any known styles for achieving the intended results and is far superior to that of the prior art. Precision is a hallmark of the present invention. This precision, flexibility and interchangeability greatly increase arc-on time for any robotic cell approaching thousandths of an inch in variability thereby greatly improving production cycling.

### SUMMARY OF THE INVENTION

The system and method of the present invention is differentiated from the prior art in that it broadly comprises a stationary main base, a welding robot (or other functioning operational structure that is tended for a different purpose) secured to the main base, at least one movable cart (a welding cart in this example), and a float unit structure used for temporarily “docking” the movable welding cart to the stationary main base. A portion of the float unit structure resides with the main base and another portion resides with each of the carts desired or required.

That is, the main base and the welding cart include complementary structures to form a float unit structure that allows the welding cart, and any other carts that are similarly configured, to immovably “dock” with the main base in a uniform fashion, thereby reducing time for adjusting each cart relative to the main base as would otherwise be required. This ensures that each welding cart that docks with the main base does so in such a way that the same precise spatial positioning between the welding robot and items secured to the welding cart are universally maintained.

It is generally understood that conventional welding robots have many parts, including mechanical units, controllers, and other components. The mechanical unit, also called the manipulator, is that part of the robot that makes it move. The design of the mechanical unit can be categorized into different types, such as Selective Compliance Assembly Robot Arm or Selective Compliance Articulated Robot Arm (both “SCARA” robots)—a type of industrial robot. SCARA robots are known for their unique configuration, which allows them to be compliant in the X-Y axis and rigid in the Z-axis. This flexibility makes them well-suited for tasks that require high speed and accuracy, such as assembly, pick-and-place, and sorting. The controller is that part of the robot that acts as its “brain”. Other components include valves, fittings, air filters, pressure sensors, regulators, lubricators, and lube filters. Pneumatics are used for gripper actuation and vacuum generation. Relative to the present application, however, electrodes are components that are provided for resistance spot welding, together with bulk electrode wire supply holder and wire feeder for MIG and some TIG arc welding, and laser for laser welding, all typically mounted at the distal end of the cobot arm.

Referring back to the construct of the present invention (though not limited to such), there is an initial “docking” during which an operator can manually move and manipulate the arm of the cobot such that, as in this case, the welding electrode can be “touched” to each part mounted on the weldment base where welding needs to occur. The cobot will remember each such “touch point” disposed on each weldment base with the help of its user via an input device. This allows the cobot to repetitiously perform its welding functions while another weldment base is being prepared, that weldment base requiring the same precise weldment touch points as the weldment base that came before it. It is to be understood that the same use of the cobot could be attained via a conventional robot but in a slightly different way. In either instance, the system and method of the present invention substantially reduces “arc off” time and increases productivity. In both instances, the carts and base units configured in accordance with the present invention utilize the “float” construct to accomplish accurate and repeated use of like-configured carts, irrespective of the particular application desired or required by the user. Again, a portion of the float unit structure of the universal fixturing system of the present invention resides with the main base and another portion resides with the cart.

The foregoing and other features of the float unit structure of the present invention as used in accordance with the system and method of the present invention will be apparent from the detailed description that follows.

### BRIEF DESCRIPTION OF THE DRAWINGS

FIG. 1 is a first side and top perspective view of the system constructed in accordance with the present invention, the system generally comprising a cobot base coupled to a rolling welding cart, the cart having a weld top or table.

FIG. 2 is a second perspective view of the system shown in FIG. 1 and generally showing a side of the system.

FIG. 3 is a third side perspective view of the system shown in FIG. 1 and generally showing a front and side view of the system.

FIG. 4 is a fourth perspective view of the system shown in FIG. 1 and generally showing a front, top and side view of the system.

FIG. 5 is a fifth perspective view of the system shown in FIG. 1 and generally showing a top perspective view of the system.

FIG. 6 is a perspective view of an operator placing and positioning work products on the weld or welding table for later access to them by the welding head of the cobot.

FIG. 7 is a perspective view of an operator interacting with the cobot to manually establish certain “points” for the welding head of the cobot to “touch” once the welding cart is secured to the cobot base using the float structure described herein.

FIG. 8 is another perspective view showing details of the base-side portion of the float unit structure.

FIG. 9 is another perspective view showing details of the cart-side portion of the float unit structure.

### DETAILED DESCRIPTION OF THE INVENTION

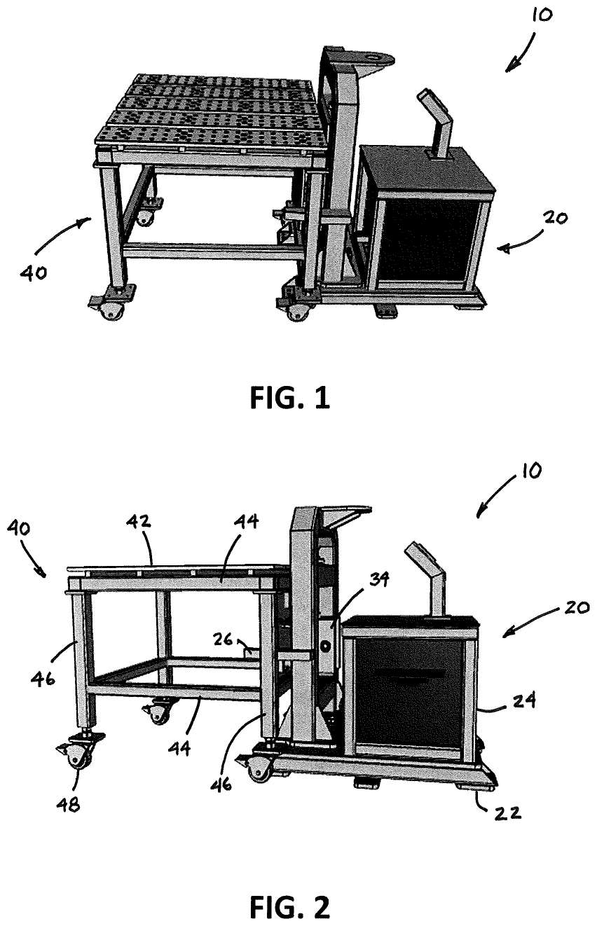

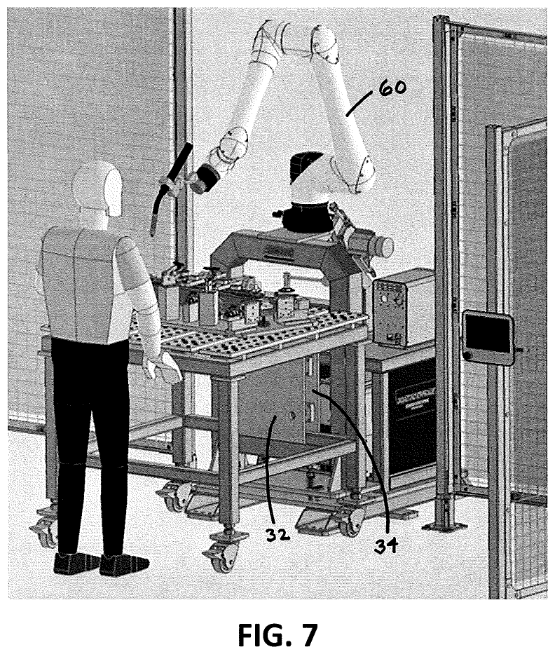

Referring now to the drawings, FIGS. 1 and 7 show portions of a system, generally identified 10, that broadly comprises a stationary main cobot base, generally identified 20, a welding robot 60 secured to the main base 20, and at least one movable welding cart, generally identified 40, and means 50, 70 for lining up and temporarily “docking” the movable welding cart 40 to the stationary main cobot base 20. This docking is accomplished using electromechanical principles and, once docked, the docking is intentionally immovable. Note that the word “table” may be used synonymously for the cart 40. Also note that the main base 20 and each cart 40 is provided with portions of a “float unit structure” 50, 70, respectively.

There is a “set up” stage that is included within the method of the present invention during which the moveable welding cart 40 is positioned, or “docked”, next to the stationary main base 20. It is this docking functionality that distinguishes the system 10 and method of the present invention from the prior art. With the present invention multiple carts 40 can be uniformly prepped prior to docking. See FIG. 6. Once the welding “points” are manually set by the operator using the cobot 60 and directing its distal end to that “point”, other carts 40 that are similarly configured can be docked with such precision that reprogramming of the cobot 60 is not required because the docking is exactly the same for each cart 40 presented. For carts 40 that are using the same welding scheme, the cobot 60 will weld the same welding spots or locations that were set by the operator and cobot 60 during the initial set up. That is, the same spatial positioning between the cobot welding robot 60 and items 62 secured to the welding cart 40 will match for each similarly-configured set of items 62.

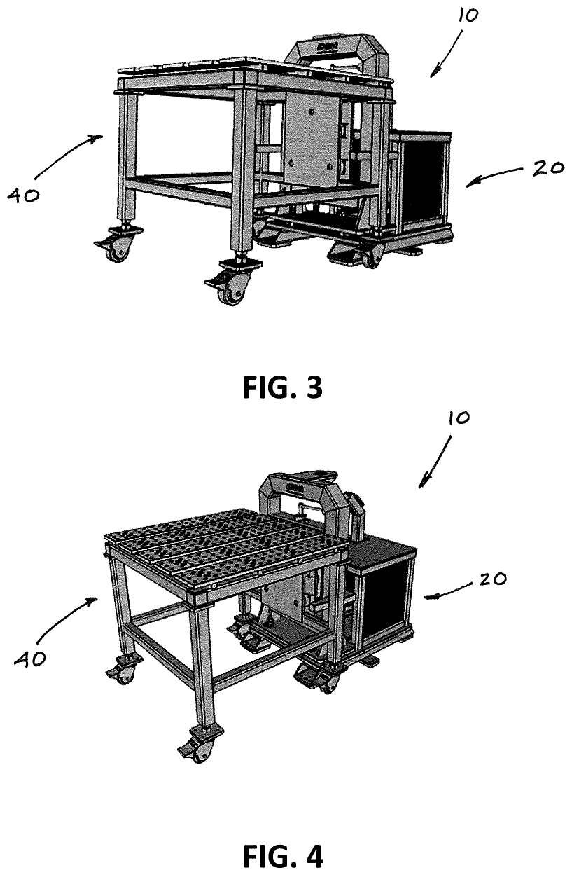

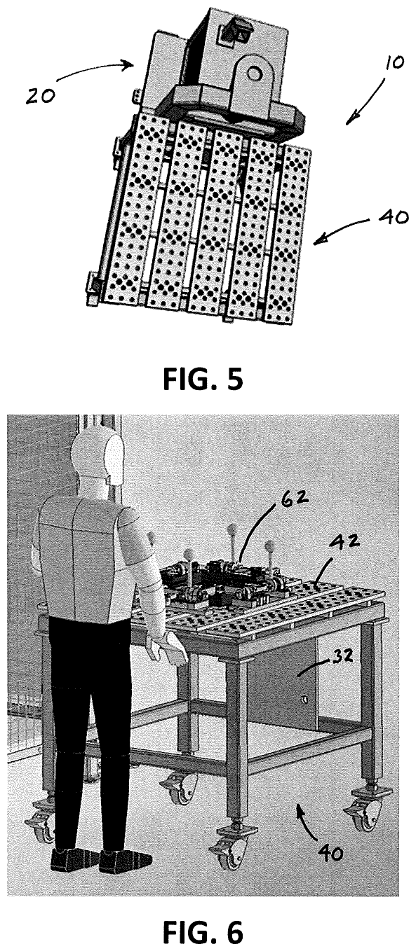

Referring now to FIGS. 1-5 in particular, it will be seen that the welding cart or table 40 comprises a welding deck 42, a plurality of horizontal frame members 44, a plurality of height adjustable vertical frame members 46, and lockable rollers 48, the rollers 48 being height adjustable as well. As shown for this embodiment, the table 40 is cubical in shape and movable. The welding deck 42 is that portion of the table 40 that the operator uses to place and position the items 62 to be welded. Again, see FIG. 6.

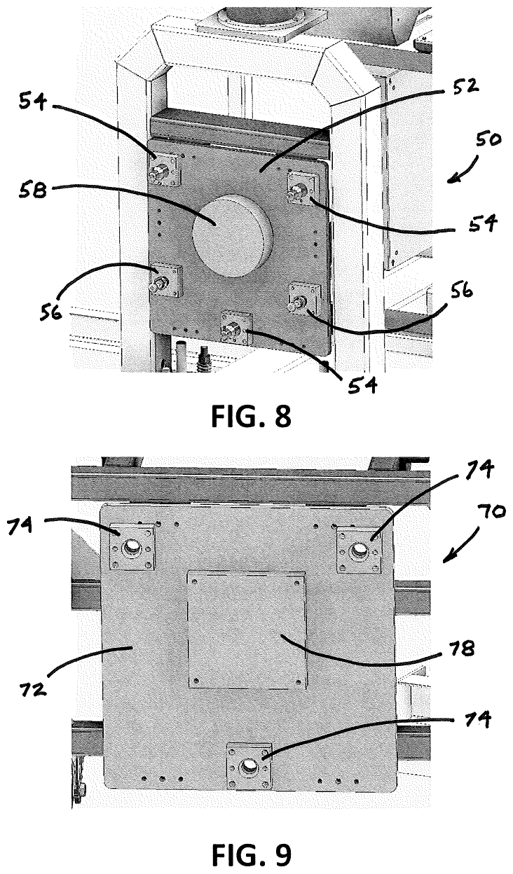

Referring to the same FIGS. 1-5, it will be seen that the cobot mount base 20 is intended to be placed in a work station. This is done in a way that ultimately results in the base 20 being immovable by means of floor surface pads 22 or like structure. The cobot base 20 likewise comprises a housing 26 having vertical and horizontal supports and side panels within which the hardware (not shown) for the cobot 60 is contained. To the front side of the cobot base 20, a pair of alignment structures 24 is provided. The alignment structures 24 are secured at a distance from one another that substantially matches the distance between the forwardmost vertical frame members 46 of the weld table 40. But alternative alignment structures could be provided as a design contingency. Any such structure is provided to allow the operator to easily position the table 40 relative to the base 20. Once the operator generally positions those elements together, the float unit structure portions 50, 70 take over. That is, the main base 20 and the welding cart 40 include complementary structures allowing the welding cart 40 to “dock” with the main base 20, the main base 20 and each cart 40 being provided with portions 50, 70 of the “float unit structure”, respectively. See FIGS. 8-9 in particular.

As to the float unit structure portion 50 that is configured for use with the main base 20, reference is again made to FIGS. 8 and 9. As to this portion 50 of the float unit structure, it will be seen that the preferred embodiment comprises an interface plate 52. The interface plate 52 comprises a plurality of alignment pins 54, a plurality of complementary shock absorbing structures 56 and a holding electromagnet 58 that is immovably secured by mechanical means to the interface plate 52.

As to the float unit structure portion 70 that is configured for use with each movable welding cart 40, reference is now made to FIG. 9. As to this portion 70 of the float unit structure, it will be seen that the preferred embodiment comprises an interface plate 72. The interface plate 72 comprises a plurality of alignment pin receivers 74 and a forwardly-extending face plate ferrous contact surface or face plate 78.

During the “floating” and “docking” of the cart 40 to the main base 20, the alignment pins 54 of the float unit structure of the main base 20 are received within the alignment pin receivers 74. In the preferred embodiment, a medial portion of each alignment pin 54 is conical in shape so as to allow for forced and centered alignment of those complementary structures, each receiver 74 being conical in shape as well. Next, the forwardly-extending face plate 78 is placed in close proximity to the electromagnet 58. In this position, the cart 40 and the base 20 are functionally aligned by facial alignment of the plates 58, 78. At this point, the electromagnet 58 is energized to pull the cart-side ferrous contact surface or face plate 78 toward it and immovably securing those two elements together. During each operational cycle of the cobot 60, all items 62 that are presented are precisely in the same position as that of the cart 40 before it and the cart 40 after it. The retention of each cart 40 in this fashion ensures that the items 62 are welded properly and without any reprogramming or repositioning of the cobot 60.

The electromagnet 58 includes means for energizing the electromagnet 58 (not shown), which maintains the position of the cart 40 relative to the base 20. Once the welding has been completed, the electromagnet 58 can be deenergized such that the cart 40 can be withdrawn from the base 20 and another cart 40 can be placed in position to weld another set of items 62 on top of that next cart 40.

As alluded to earlier, it is to be understood that conventional welding robots could also be used with the present invention. It simply must be recognized the welding robots have many parts, including mechanical units, controllers, and other components. The mechanical unit, also called the manipulator, is that part of the robot that makes it move. This is no different with the cobot 60 and system 10 built in accordance with the present invention. The controller is that part of the robot that acts as its “brain” and the robot needs to be programmed to operate the same as the cobot 60 discussed in this preferred embodiment.

It is also to be understood that the system 10 of the present invention is not limited to welding applications. For example, pneumatics could be used for gripper actuation and vacuum generation. Relative to the present application, however, electrodes are the components provided for resistance spot welding. As stated earlier, an operator can manually move and manipulate the arm of the cobot 60 such that the welding electrode can be “touched” to each part 62 mounted on the weldment deck 42 where welding needs to occur. The cobot 60 will remember each such “touch point” disposed on each like-configured weldment decks 42 in its “teach” mode. This allows the cobot to perform its welding functions while another weldment base 42 is being prepared, that weldment base 42 requiring the same weldment touch points as the weldment base 42 that came before it and the weldment base 42 that comes after it. This substantially reduces “arc off” time and increases productivity.

1. A fixturing system comprising:
a base;
a cart; and
a float unit structure;
wherein the base and the cart are each provided with a complementary portion of the float unit structure.

2. The fixturing system of claim 1 wherein the base further comprises:
a housing having a front vertical face;
a base-side float unit structure portion comprising an interface plate disposed on the front vertical face of the housing, the interface plate further comprising:
a plurality of alignment pins;
a plurality of shock absorbing structures;
a holding electromagnet that is immovably affixed to the interface plate.

3. The fixturing system of claim 2 wherein the cart further comprises:
a cart-side float unit structure portion comprising a cart-side interface plate, the cart-side interface plate further comprising:
a plurality of alignment pin receivers; and
a ferrous contact surface or face plate extending forwardly of the cart-side interface plate.

4. The fixturing system of claim 3 wherein:
the alignment pins are configured and positioned to be complementarily received within the alignment pin receivers; and
the forwardly extending face plate of the cart-side interface plate is configured and positioned to be immovably held in place when the electromagnet of the base is energized.

5. The fixturing system of claim 4 wherein each alignment pin comprises a length, a portion of the length being conical in shape.

6. The fixturing system of claim 4 wherein the base further comprises a cobot and the cart comprises a top having a welding deck wherein the immovable electromechanical connection between the energized electromagnet and the forwardly extending face plate of the cart-side interface plate allows the cobot to interact with the welding deck disposed on top of the base and items to be welded disposed on the welding deck in accordance with a preprogrammed scheme.

7. The fixturing system of claim 6 wherein the cart comprises a plurality of carts, each cart being identically configured such that any cart from the plurality of carts can connect with the base to allow the cobot to consistently and uniformly interact with the top of the base and items to be welded.

8. The fixturing system of claim 4 wherein the rearwardly extending plate of the base makes an immovable mechanical connection between the rearwardly extending plate and the forwardly extending face plate of the cart-side interface plate prior to and when the cobot is interacting with a welding deck table disposed on top of the base and items to be welded disposed on the welding deck in accordance with a preprogrammed scheme.

9. The fixturing system of claim 8 wherein the cart comprises a plurality of carts, each cart being identically configured such that any cart from the plurality of carts can connect with the base to allow the cobot to consistently interact with the top of the base and items to be welded and in accordance with a preprogrammed scheme.

10. A fixturing system comprising:
a docking base;
a cobot disposed on the docking base;
a plurality of carts configured to achieve precision alignment and docking of each cart of the plurality of carts with the docking base;
a welding deck disposed on a top of each cart of the plurality of carts;
wherein the cobot is operable in accordance with a preprogrammed scheme to precisely weld points on the welding deck on each cart of the plurality of carts.

11. The fixturing system of claim 10 wherein the docking base further comprises a housing having a front vertical face; a base-side float unit structure portion comprising an interface plate disposed on the front vertical face of the housing, the interface plate further comprising a plurality of alignment pins; a plurality of shock absorbing structures;
a holding electromagnet immovably disposed on the interface plate; and wherein each cart further comprises a cart-side float unit structure portion comprising a cart-side interface plate, the cart-side interface plate further comprising a plurality of alignment pin receivers; and a ferrous contact surface or face plate extending forwardly of the cart-side interface plate.

12. The fixturing system of claim 11 wherein the alignment pins are configured and positioned to be complementarily received within the alignment pin receivers; and the forwardly extending face plate of the cart-side interface plate is configured and positioned to be complementarily secured to the electromagnet of the base-side interface plate when the electromagnet is energized.
